(19) United States
(12) Patent Application Publication
(10) Pub. No.: US 2016/0047755 A1
(43) Pub. Date: Feb. 18, 2016

(54) OPTICAL MEASURING APPARATUS AND METHOD FOR MEASURING PATTERNED SAPPHIRE SUBSTRATE

(71) Applicant: CHENG MEI INSTRUMENT TECHNOLOGY CO., LTD., Hsinchu County (TW)

(72) Inventor: Cheng-Tao TSAI, Hsinchu County (TW)

(21) Appl. No.: 14/829,302

(22) Filed: Aug. 18, 2015

Related U.S. Application Data
(60) Provisional application No. 62/038,546, filed on Aug. 18, 2014.

(51) Int. Cl. G01N 21/95; G01J 1/04; F21V 8/00

(52) U.S. Cl. CPC G01N 21/95; G02B 6/0008; G01J 1/0425; G02B 2006/0098

(57) ABSTRACT

An optical measuring apparatus with a light source, an optical fiber connector, an optical probe, a plurality of optical fibers and an imaging processor is provided. The light source emits a first light beam. The optical fiber connector is disposed adjacent to the light source. The optical probe is disposed adjacent to the fiber connector and opposite the light source. The optical fibers are utilized to connect the light source, the optical fiber connector and the optical probe. The imaging processor is disposed on the same side as the light source, and is connected with the optical fiber connector.

This application claims priority to U.S. Provisional Patent Application No. 62/038,546 filed on Aug. 18, 2014.

### CROSS-REFERENCES TO RELATED APPLICATIONS

Not applicable.

### BACKGROUND OF THE INVENTION

1. Field of the Invention

The present invention relates to an optical measuring apparatus and an optical measuring method for measuring a patterned sapphire substrate, and more particularly, to an optical measuring apparatus and an optical measuring method for measuring the conditions of the surface of a patterned sapphire substrate by using optical confocal technology.

2. Descriptions of the Related Art

In the prior art, a patterned sapphire substrate (PSS) is measured mainly by using scanning electron microscopy (SEM). However, due to the limitation of the resolution of the scanning electron microscopy, an area of the patterned sapphire substrate that is to be measured needs to be cut down first to perform a subsequent measurement thereon when the measurement is performed by scanning electron microscopy.

In other words, the current method for measuring the patterned sapphire substrate by using the scanning electron microscopy is a kind of sampled and destructive measurement, which not only destroys the integrity of the patterned sapphire substrate to be measured but also makes the specific area that is cut down and measured non-reusable. Meanwhile, even if no defect is found in the patterned sapphire substrate that is sampled for measurement, there still may be undetected defects in patterned sapphire substrates that are actually used as parts of products due to the nature of the sampling measurement, and this will influence subsequent processing.

Accordingly, it is important to provide an optical measuring apparatus and an optical measuring method for measuring a patterned sapphire substrate, which can avoid damage to the patterned sapphire substrate during the early measurement process and meanwhile improve the reproducibility of the measurement of the surface of the patterned sapphire substrate.

### SUMMARY OF THE INVENTION

An objective of the present invention is to provide an optical measuring apparatus and an optical measuring method for measuring the conditions of the surface of a patterned sapphire substrate, which can perform non-destructive measurement on the surface of the patterned sapphire substrate during the measurement process to obtain more accurate measurement data and to improve the reproducibility of the measurement of the surface of the patterned sapphire substrate.

To achieve the aforesaid objective, an optical measuring apparatus of the present invention comprises a light source, an optical fiber connector, an optical probe, a plurality of optical fibers and an imaging processor. The light source is adapted to emit a first light beam; the optical fiber connector is disposed adjacent to the light source; the optical probe is disposed adjacent to the optical fiber connector and opposite the light source; the plurality of optical fibers are adapted to connect the light source, the optical fiber connector and the optical probe respectively; and the imaging processor is disposed on the same side as the light source and connected with the optical fiber connector. The first light beam emitted from the light source travels through the optical fiber connector and the optical probe sequentially via the optical fibers to be converged onto the surface of a patterned sapphire substrate, and is then reflected by the surface of the patterned sapphire substrate into a second light beam. The second light beam travels through the optical probe and the optical fiber connector sequentially and is then received by the imaging processor so that an imaging analysis is performed on the second light beam.

To achieve the aforesaid objective, the optical probe comprised in the optical measuring apparatus of the present invention has a pinhole near the optical connector so that the first light beam travels through the pinhole. The optical probe defines the measurement focus on the surface of the patterned sapphire substrate. The pinhole and the measurement focus are conjugate to each other.

To achieve the aforesaid objective, the optical probe comprised in the optical measuring apparatus of the present invention is adapted to perform a global scanning along the surface of the patterned sapphire substrate.

To achieve the aforesaid objective, the optical probe comprised in the optical measuring apparatus of the present invention is adapted to move up and down in a vertical direction.

To achieve the aforesaid objective, the light source comprised in the optical measuring apparatus of the present invention is a full-wavelength light source including visible light rays and invisible light rays.

To achieve the aforesaid objective, the present invention further comprises an optical measuring method, which comprises the following steps: (a) inspecting a surface of a patterned sapphire substrate through an automated optical inspection (AOI) procedure to define a non-defective area and a defective area; (b) providing a light source to emit a first light beam; and (c) directing the first light beam through an optical fiber connector and an optical probe sequentially to focus on a measurement focus defined on the surface of the patterned sapphire substrate. The measurement focus is located within the non-defective area, the optical probe has a pinhole at a position corresponding to the measurement focus so that the first light beam travels through the pinhole. The pinhole and the measurement focus are conjugate to each other.

To achieve the aforesaid objective, the optical measuring method of the present invention further comprises the following step: (d) providing an imaging processor so that after the first light beam is reflected by the surface of the patterned sapphire substrate into a second light beam, the second light beam is received and analyzed by the imaging processor.

To achieve the aforesaid objective, the imaging processor used in the optical measuring method of the present invention is disposed on the same side as the light source and is connected with the optical fiber connector.

To achieve the aforesaid objective, the optical probe used in the optical measuring method of the present invention is adapted to perform a global scanning along the non-defective area of the surface of the patterned sapphire substrate.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an optical measuring apparatus of the present invention;

FIG. 2 is a schematic view of the propagating path of the first light beam in the optical measuring apparatus of the present invention;

FIG. 3 is a schematic view of the propagating path of the second light beam in the optical measuring apparatus of the present invention; and

FIG. 4 is a flowchart diagram of an optical measuring method of the present invention.

### DESCRIPTION OF THE PREFERRED EMBODIMENT

An optical measuring apparatus 100 for measuring a patterned sapphire substrate 200 according to this application measures a surface 210 of the patterned sapphire substrate 200 mainly in a contactless way by use of a confocal light beam and by changing parameters such as the intensity and the focus position of the confocal light beam to obtain such values as the morphology, the sphere diameter and the bottom width of the surface 210 of the patterned sapphire substrate 200 for use in subsequent processing.

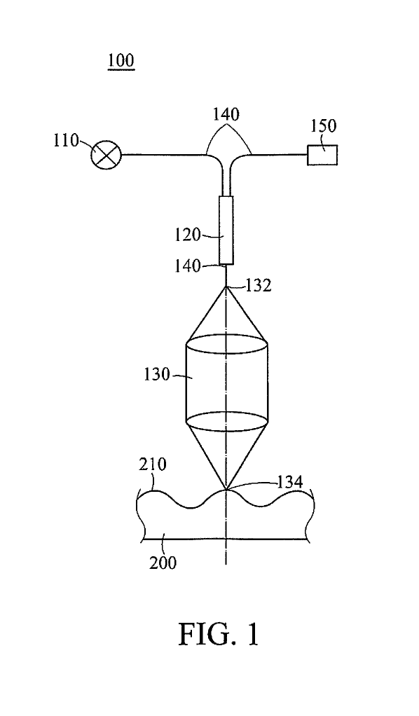

As shown in FIG. 1, the optical measuring apparatus 100 of the present invention comprises, among others, a light source 110, an optical fiber connector 120, an optical probe 130, a plurality of optical fibers 140 and an imaging processor 150.

The light source 110 is adapted to emit a first light beam 300. The optical fiber connector 120 is disposed adjacent to the light source 110. The optical probe 130 is disposed adjacent to the optical fiber connector 120 and opposite the light source 110. The plurality of optical fibers 140 are adapted to connect the light source 110, the optical fiber connector 120 and the optical probe 130 respectively to facilitate the transmission of the first light beam 300 between the light source 110, the optical fiber connector 120 and the optical probe 130. The imaging processor 150 is disposed on the same side as the light source 110 and connected with the optical fiber connector 120.

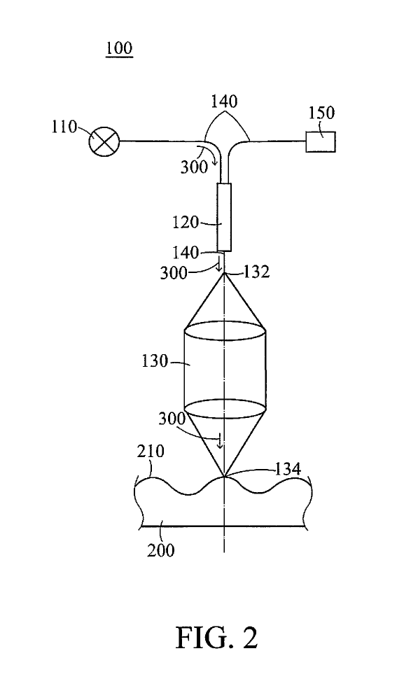

Next, with reference to FIG. 2, the first light beam 300 emitted from the light source 110 travels through the optical fiber connector 120 and the optical probe 130 sequentially via the optical fibers 140 to be converged onto the surface 210 of the patterned sapphire substrate 200.

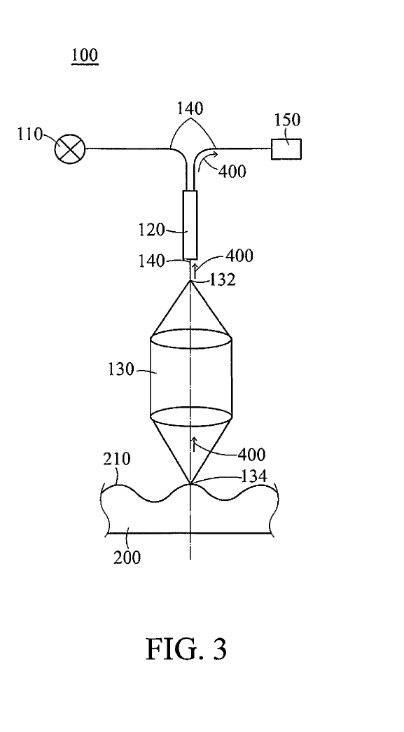

After the first light beam 300 is converged onto the surface 210 of the patterned sapphire substrate 200, the first light beam 300 is reflected by the surface 210 of the patterned sapphire substrate 200 into a second light beam 400. Thus, as shown in FIG. 3, the second light beam 400 then travels through the optical probe 130 and the optical fiber connector 120 sequentially via the optical fibers 140 in a propagating direction opposite to that of the first light beam 300, and is then received by the imaging processor 150 so that the imaging processor 150 can perform the imaging analysis on the second light beam 400.

In detail, with reference back to FIG. 1, the optical probe 130 comprised in the optical measuring apparatus 100 of the present invention has a pinhole 132 at one side near the optical connector 120 so that the first light beam 300 can enter into the optical probe 130 through the pinhole 132. Moreover, the optical probe 130 defines a measurement focus 134 at the other side opposite to the pinhole 132 (i.e., at the side adjacent to the surface 210 of the patterned sapphire substrate 200). The pinhole 132 and the measurement focus 134 are conjugate to each other.

Generally, when the first light beam 300 is focused onto the measurement focus 134 on the surface 210 of the patterned sapphire substrate 200 and then reflected by the surface 210 of the patterned sapphire substrate 200 into the second light beam 400, images not belonging to the measurement focus 134 will be filtered out when the second light beam 400 travels through the pinhole 132 of the optical probe 130 from bottom to top because the pinhole 132 and the measurement focus 134 are conjugate to each other. Therefore, the second light beam 400 received by the imaging processor 150 has a high resolution, and this improves the reproducibility of a stereoscopic profile corresponding to the stereoscopic modeling performed by the imaging processor 150 on the surface 210 of the patterned sapphire substrate 200.

Thus, by changing parameters such as the intensity and focus position of the first light beam 300 and making the optical probe 130 perform scanning along the surface 210 of the patterned sapphire substrate 200, the surface 210 of the patterned sapphire substrate 200 can be measured in a contactless manner, which effectively avoids the constructive measurement described in the prior art in which the patterned sapphire substrate 200 needs to be cut.

Meanwhile, since the optical measuring apparatus 100 of this application performs the measurement in a contactless manner, the optical measuring apparatus 100 of this application can implement the measurement by performing a partial or global scanning on the surface 210 of the patterned sapphire substrate 200 without having to cut the patterned sapphire substrate 200 to cause waste to the patterned sapphire substrate 200.

Furthermore, the optical probe 130 comprised in the optical measuring apparatus 100 of this application may also move up and down in a vertical direction to adjust the relative position of the measurement focus 134 in response to the change of the surface 210 of the patterned sapphire substrate 200. On the other hand, the up and down movement of the optical probe 130 also helps the imaging processor 150 in calculating and reckoning the bottom width and the sphere diameter of the patterned sapphire substrate 200 to obtain more accurate values.

In an embodiment of the present invention, the light source 110 is a full-wavelength light source including visible light rays and invisible light rays. The first light beam 300 is preferred to be a confocal white laser beam.

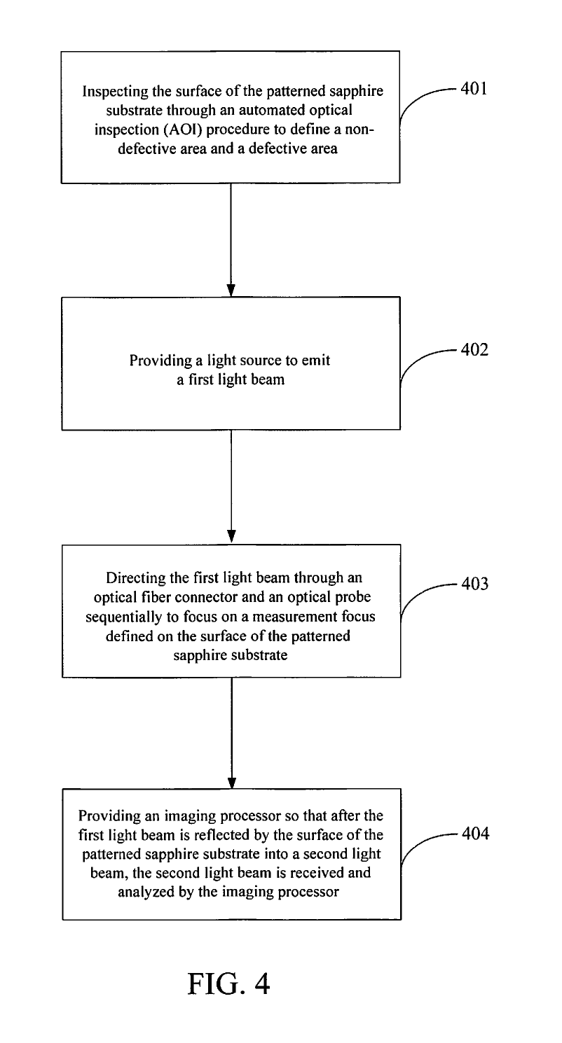

As shown in FIG. 4, the present invention further discloses an optical measuring method for measuring the conditions of the surface 210 of the patterned sapphire substrate 200, which comprises the following steps.

First, as shown in step 401, the surface 210 of the patterned sapphire substrate 200 is inspected through an automated optical inspection (AOI) procedure to define a non-defective area and a defective area; then, as shown in step 402, a light source 110 is provided to emit a first light beam 300; as shown in step 403. The first light beam 300 is directed through an optical fiber connector 120 and an optical probe 130 sequentially to focus on the measurement focus 134 defined on the surface 210 of the patterned sapphire substrate 200. Finally, as shown in step 404, an imaging processor 150 is provided so that after the first light beam 300 is reflected by the surface 210 of the patterned sapphire substrate 200 into a second light beam 400, the second light beam 400 is received and analyzed by the imaging processor 150. The measurement focus 134 is located within the non-defective area, the optical probe 130 has a pinhole 132 on the side corresponding to the measurement focus 134 so that the first light beam 300 travels through the pinhole 132, and the pinhole 132 and the measurement focus 134 are conjugate to each other.

Thus, after the surface 210 of the patterned sapphire substrate 200 is inspected through the automated optical inspection (AOI) procedure to define the non-defective area and the defective area preliminarily, it can be ensured that the optical measuring apparatus 100 and the optical measuring method of this application can directly work on the correct measurement area to effectively avoid occurrence of error values. Thereafter, due to the fact that the pinhole 132 and the measurement focus 134 are conjugate to each other and by adjusting the values such as the intensity and the focus position of the first light beam 300, very accurate parameters (e.g., the pattern height, the sphere diameter, the head width and the bottom width of the patterned sapphire substrate 200) can be captured by the imaging processor 150 at a high speed according to measured data such as the wavelength and the energy variation of the reflected second light beam 400. Therefore, the contactless measuring method disclosed in this application can be used to not only measure the surface 210 of the patterned sapphire substrate 200 of this application as described in the aforesaid embodiment, but also measure other substrates or panels.

When the optical measuring apparatus 100 and the optical measuring method of this application are used to measure the patterned sapphire substrate 200, data such as the height variation of the surface 210 of the patterned sapphire substrate 200 and the wavelength variation of the first light beam 300 reflected by the patterned sapphire substrate 200 can be obtained simultaneously from a single scanning path and within a single scanning duration. Therefore, the imaging processor 150 can calculate and output the 3D profile of the surface 210 of the patterned sapphire substrate 200 by operating on these data appropriately. On the other hand, data such as the pattern height, the sphere diameter, the head width and the bottom width of the patterned sapphire substrate 200 may also be calculated from the wavelength variation of the first light beam 300 obtained as described above.

According to the above descriptions, the optical measuring apparatus 100 and the optical measuring method for measuring the patterned sapphire substrate 200 of the present invention can maintain the integrity of the patterned sapphire substrate 200 during the measurement of the surface 210 of the patterned sapphire substrate 200. Therefore, damage to the patterned sapphire substrate 200 that is measured can be avoided and the production cost resulting from the damage of the patterned sapphire substrate 200 can be further reduced. On the other hand, because the optical measuring apparatus 100 and the optical measuring method for measuring the patterned sapphire substrate 200 of this application are non-destructive, they may also be used to partially or globally measure the patterned sapphire substrate 200 to effectively manage the quality of the resulting products.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An optical measuring apparatus for measuring conditions of a surface of a patterned sapphire substrate (PSS), comprising:
a light source, being adapted to emit a first light beam;
an optical fiber connector disposed adjacent to the light source;
an optical probe disposed adjacent to the optical fiber connector and opposite the light source;
a plurality of optical fibers, being adapted to connect the light source, the optical fiber connector and the optical probe; and
an imaging processor disposed at the same side as the light source and connected with the optical fiber connector;
wherein the first light beam emitted from the light source travels through the optical fiber connector and the optical probe sequentially via the optical fibers so as to be converged onto the surface of the patterned sapphire substrate, and is then reflected by the surface of the patterned sapphire substrate into a second light beam, and the second light beam travels through the optical probe and the optical fiber connector sequentially and is then received by the imaging processor so that an imaging analysis is performed on the second light beam.

2. The optical measuring apparatus of claim 1, wherein the optical probe has a pinhole near the optical connector so that the first light beam travels through the pinhole, the optical probe defines a measurement focus on the surface of the patterned sapphire substrate, and the pinhole and the measurement focus are conjugate to each other.

3. The optical measuring apparatus of claim 1, wherein the optical probe is adapted to perform a global scanning along the surface of the patterned sapphire substrate.

4. The optical measuring apparatus of claim 1, wherein the optical probe is adapted to move up and down in a vertical direction.

5. The optical measuring apparatus of claim 1, wherein the light source is a full-wavelength light source including visible light rays and invisible light rays, and the first light beam is a laser beam.

6. An optical measuring method for measuring conditions of a surface of a patterned sapphire substrate (PSS), comprising the following steps of:
inspecting the surface of the patterned sapphire substrate through an automated optical inspection (AOI) procedure to define a non-defective area and a defective area;
providing a light source to emit a first light beam; and
directing the first light beam through an optical fiber connector and an optical probe sequentially to focus on a measurement focus defined on the surface of the patterned sapphire substrate;
wherein the measurement focus is located within the non-defective area, the optical probe has a pinhole at a position corresponding to the measurement focus so that the first light beam travels through the pinhole, and the pinhole and the measurement focus are conjugate to each other.

7. The optical measuring method of claim 6, further comprising the following step of
providing an imaging processor so that after the first light beam is reflected by the surface of the patterned sapphire substrate into a second light beam, the second light beam is received and analyzed by the imaging processor.

8. The optical measuring method of claim 7, wherein the imaging processor is disposed at the same side as the light source and is connected with the optical fiber connector.

9. The optical measuring method of claim 6, wherein the optical probe is adapted to perform a global scanning along the non-defective area of the surface of the patterned sapphire substrate.

10. The optical measuring method of claim 6, wherein the light source is a full-wavelength light source including visible light rays and invisible light rays.
